(19) United States
(12) Patent Application Publication
(10) Pub. No.: US 2026/0324680 A1
(43) Pub. Date: Oct. 22, 2026

(54) GEL COMPOSITIONS AND THEIR USE IN SEAFOOD ANALOGUE PRODUCTS

(71) Applicant: Firmenich SA, Satigny (CH)

(72) Inventors: Andrea GIAVON, Collecchio (IT); Igor BODNAR, Satigny (CH)

(73) Assignee: Firmenich SA, Satigny (CH)

(21) Appl. No.: 18/997,936

(22) PCT Filed: Aug. 17, 2023
(86) PCT No.: PCT/EP2023/072717

§ 371 Date: Jan. 23, 2025

Related U.S. Application Data
(60) Provisional application No. 63/399,796, filed on Aug. 22, 2022.

(30) Foreign Application Priority Data
Sep. 2, 2022 (EP) 22193781.6

(51) Int. Cl. A23J 3/22; A23J 3/16; A23L 27/00; A23L 29/269; A23L 33/115; A23L 33/16; A23L 33/21

(52) U.S. Cl. CPC A23J 3/227; A23J 3/16; A23L 27/88; A23L 29/272; A23L 33/115; A23L 33/16; A23L 33/21

(57) ABSTRACT

The present disclosure relates generally to gel compositions that are useful for simulating the texture of certain commonly consumed shellfish products. In some embodiments, the gel compositions are free of any animal-derived, fish-derived, or shellfish-derived ingredients. In general, the gel compositions comprise a gelled polysaccharide, such as a gelled gellan gum. The gel compositions further comprise one or more non-animal proteins, such as proteins derived from plants, algae, or fungi. In some embodiments, the gel composition comprises an insoluble fiber, such as bamboo fiber. In certain aspects, the gel compositions can be used to form vegan replicas of certain fish or shellfish products, such as vegan replicas of salmon meat, shrimp meat, crab meat, squid meat (calamari), octopus meat, lobster meat, and cuttlefish meat.

### TECHNICAL FIELD

The present disclosure relates generally to gel compositions that are useful for simulating the texture of certain commonly consumed shellfish products. In some embodiments, the gel compositions are free of any animal-derived, fish-derived, or shellfish-derived ingredients. In general, the gel compositions comprise a gelled polysaccharide, such as a gelled gellan gum or konjac gum. In some embodiments, the gel compositions further comprise one or more non-animal proteins, such as proteins derived from plants, algae, or fungi. In some embodiments, the gel composition comprises an insoluble fiber, such as bamboo fiber. In certain aspects, the gel compositions can be used to form vegan replicas of certain fish or shellfish products, such as vegan replicas of salmon meat, shrimp meat, crab meat, squid meat (calamari), octopus meat, lobster meat, and cuttlefish meat.

### DESCRIPTION OF RELATED ART

The human diet generally includes a combination of meat, seafood, plants, fungi, and algae. In recent years, the proportion of calories consumed meat and seafood has increased, as a larger proportion of the global population has moved out of poverty. In many cases, the demand for seafood is growing at a pace too great to permit sustainable fishing of many seafood products. Further, a substantial number of people have dangerous allergies to shellfish and are unable to enjoy such products. And others avoid seafood products for ethical reasons.

Thus, there is increasing demand to replace seafood in the human diet with similar materials derived from plants, algae, and fungi. In many cases, because consumers have become accustomed to consuming seafood, these non-seafood-based alternative foods are designed to simulate the flavor, texture, and culinary experience of consuming seafood. But creating such seafood analogue materials poses a number of challenges, as one attempts to use non-seafood-derived materials to create a food product that simulates eating seafood.

One such challenge involves creating non-seafood-based materials that have the texture and nutritional profiles of shellfish, such as shrimp, crab, squid (calamari), octopus, lobster, and cuttlefish. Shellfish analogue products have appeared on the market in recent years. These products tend to be based on a combination of polysaccharide gels and starch. Thus, they tend to be much higher in carbohydrates (and calories) than shellfish, and much lower in protein than shellfish. One benefit of eating shellfish is that it tends to be low in calories and carbohydrates and high in protein. These high-starch seafood analogue products fail to provide such nutritional benefits.

Therefore, there is a continuing need to develop materials that can be used to make fish or shellfish analogue products that better simulate the nutritional profile, particularly the protein content, of actual fish or shellfish meat.

### SUMMARY

The present disclosure relates to the discovery of certain gel compositions suitable for use in making non-seafood replicas of fish or shellfish products.

In a first aspect, the disclosure provides an ingestible composition comprising: gellan gum, and a non-animal protein. In some embodiments, the gellan gum comprises high-acyl gellan gum and low-acyl gellan gum. In some embodiments, the plant protein is soy protein, pea protein, or a combination thereof. In some embodiments, the ingestible composition comprises a plant fiber. In some embodiments, the ingestible composition comprises a lipid component, such as a plant-based oil or fat, a seafood-based oil or fat, or a combination thereof. In some embodiments, the ingestible composition comprises a flavoring, such as a seafood flavoring. In some embodiments, the ingestible composition comprises an alkali metal or alkaline earth metal salt, such as a sodium, potassium, calcium, or magnesium salt.

In a second aspect, the disclosure provides a flavored product comprising an ingestible composition of the first aspect. In some embodiments, the flavored product is a food product, such as a seafood analogue product, such as a salmon analogue product, a squid analogue product, or a shrimp analogue product. In some embodiments, the flavored product is a meat analogue product, such as a poultry analogue product.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

As used herein, the term “gellan gum” refers to a polysaccharide comprising tetrasaccharide repeating units containing two D-glucose units, one L-rhamnose unit, and one D-glucuronic acid unit, e.g., [D-Glc(β1→4) D-GlcA(β1→4) D-Glc(β1→4) L-Rha (α1→3)]ₙ, where one or two of the hydroxyl groups (namely, the hydroxyl groups attached to the 6-carbon and the 2-carbon) on one of the D-glucose units in the tetrasaccharide repeating unit is acylated, namely, by acetic acid on hydroxyl group attached to the 6-carbon and L-glyceric acid on the hydroxyl group attached to the 2-carbon. In general, about half of the tetrasaccharide units are acylated with acetic acid and L-glyceric acid in the gellan gum obtained directly from fermentation without any deacylation. This gellan gum is also referred to as “high-acyl gellan gum.” In some instances, a portion of the acyl groups are removed through a deacylation process. Gellan gums subjected to this deacylation process are referred to as “low-acyl gellan gums.”

Other terms are defined in other portions of this description, even though not included in this subsection.

### Ingestible Compositions

In certain aspects, the disclosure provides an ingestible composition comprising: gellan gum and a non-animal protein.

Any suitable gellan gum can be used. In some embodiments, the gellan gum is low-acyl gellan gum. In some other embodiments, the gellan gum is high-acyl gellan gum. In some other embodiments, the gellan gum is a mixture of low-acyl and high-acyl gellan gums. In such embodiments, the low-acyl and high-acyl gellan gums can be present in any suitable ratio relative to each other. For example, in some embodiments, the weight ratio of high-acyl gellan gum to low-acyl gellan gum in the ingestible composition ranges from 1:3 to 5:1, or from 1:2 to 4:1, or from 1:1 to 3:1. The gellan gum can make up any suitable proportion of the ingestible composition. In some embodiments, the gellan gum makes up from 1 wt % to 25 wt %, or from 2 wt % to 20 wt %, of the ingestible composition, based on the total dry weight of the ingestible composition.

Any suitable non-animal protein can be used, such as proteins derived from plants, algae, fungi, or combinations thereof. In some embodiments, the non-animal protein is a plant protein. Non-limiting examples of such plant proteins include pea protein, soy protein, hemp protein, almond protein, cashew protein, canola (rapeseed) protein, chickpea protein, wheat protein, potato protein, lupine, rice protein, fava bean protein, mung bean protein, sunflower seed protein, red lentil protein, oat protein, or any combinations thereof. In some embodiments, the plant protein is pea protein. In some embodiments, the plant protein is soy protein. The non-animal protein can be present in any suitable amount relative to the gellan gum. For example, in some embodiments, the weight ratio of non-animal protein to gellan gum ranges from 1:1 to 15:1, or from 2:1 to 12:1. The non-animal protein can make up any suitable proportion of the ingestible composition. For example, in some embodiments, the non-animal protein makes up from 20 wt % to 80 wt %, or from 30 wt % to 70 wt %, or from 40 wt % to 60 wt %, of the ingestible composition, based on the total dry weight of the ingestible composition.

Further, the protein can be in any suitable form. Some non-limiting examples of suitable forms include protein isolates, protein concentrates, textured dry powders, textured wet powders, and the like.

In some embodiments, the ingestible composition comprises an alkali metal salt, an alkaline earth metal salt, or any combination thereof. Any suitable such salts can be used, such as salts of sodium, potassium, calcium, or magnesium. These salts can employ any suitable counterion, so long as it is suitable for consumption. Some non-limiting examples of suitable counterions include chloride, sulfate, phosphate, nitrate, and the like. In some embodiments, the ingestible composition comprises an alkaline earth metal salt. In some further embodiments, the alkaline earth metal salt is a calcium salt, such as calcium chloride, calcium sulfate, or a combination thereof. In some other embodiments, the ingestible composition comprises an alkali metal salt. In some further embodiments, the alkali metal salt is a sodium salt, such as sodium chloride, sodium citrate, and the like. The salt can be present in any suitable concentration. In some embodiments, the weight ratio of gellan gum to the alkali metal or alkaline earth metal salt ranges from 1:3 to 3:1, or from 1:2 to 2:1, or from 2:3 to 3:2. The alkali metal or alkaline earth metal salt can make up any suitable proportion of the ingestible composition. In some embodiments, the alkali metal or alkaline earth metal salt make up from 1 wt % to 25 wt %, or from 2 wt % to 20 wt %, of the ingestible composition, based on the total dry weight of the ingestible composition.

In some embodiments, the ingestible composition comprises a plant fiber. Such plant fibers can be soluble fibers, insoluble fibers, or any combination thereof.

As used herein, the term “soluble fiber” refers to polysaccharides characterized as being soluble by using the method of the Association of Official Analytical Chemists (AOAC) and as set forth in Prosky et al., J. ASSOC. OFF. ANAL. CHEM., vol. 70(5), pp. 1017-1023 (1988). Any suitable soluble fibers can be used, including, but not limited to, fruit fiber (such as citrus fiber), grain fibers, psyllium husk fiber, natural soluble fibers and synthetic soluble fibers. Natural fibers include soluble corn fiber, acacia, and hydrolyzed guar gum. Synthetic soluble fibers include polydextrose, maltodextrin, modified food starch, and the like. Non-limiting examples of food-grade sources of soluble fiber include inulin, corn fiber, barley fiber, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea), Danish potatoes, konjac vegetable fiber (glucomannan), psyllium fiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polyanion compounds, cellulose fibers, cellulose fibers derived from hard wood plants and carboxymethyl cellulose. In some embodiments, the ingestible composition comprises corn fiber. In some embodiments, the ingestible composition comprises soluble corn fiber in the form of a digestion-resistant dextrin or maltodextrin.

In some embodiments, the ingestible composition includes certain insoluble fibers, which can provide structure and texture to the ingestible composition. Any suitable insoluble fiber can be used. In some embodiments, the insoluble fiber is a plant-derived fiber. Some non-limiting examples include nut fibers, grain fibers, rice fibers, seed fibers, oat fibers, pea fibers, potato fibers, berry fibers, soybean fibers, banana fibers, citrus fibers, apple fibers, bamboo fibers, and carrot fibers. In some embodiments, the insoluble fiber is bamboo fiber.

In some embodiments, the ingestible composition comprises bamboo fiber. In some such embodiments, the ingestible composition optionally includes pea fiber, citrus fiber, potato fiber, psyllium fiber, acacia fiber, inulin, konjac fiber, or any combination thereof.

The fiber can make up any suitable proportion of the ingestible composition. For example, in some embodiments, the fiber makes up from 1% by weight to 50% by weight, or from 1% by weight to 40% by weight, or from 1% by weight to 30% by weight, or from 1% by weight to 20% by weight, or from 1% by weight to 15% by weight, or from 3% by weight to 50% by weight, or from 3% by weight to 40% by weight, or from 3% by weight to 30% by weight, or from 3% by weight to 20% by weight, or from 3% by weight to 15% by weight, based on the total dry weight of the ingestible composition.

In some embodiments, the ingestible composition comprises a lipid component. In general, the lipid component is a fatty acid glyceride (such as a monoglyceride, a diglyceride, or a triglyceride), a free fatty acid, a hydrogenated derivative of any of the foregoing, or any combination thereof. The lipid component can make up any suitable portion of the ingestible composition. In some embodiments, for example, the lipid component makes up from 1 wt % to 30 wt %, or from 2 wt % to 20 wt %, or from 3 wt % to 15 wt %, based on the total dry (non-water) weight of the ingestible composition.

The lipid component can include any suitable lipid or combination of lipids. In some embodiments, the ingestible composition comprises a fat, an oil, or a combination thereof, such as a non-animal fat or oil, a seafood-based fat or oil, or a combination thereof. Any suitable non-animal fat or oil can be used in the ingestible composition, including fats derived from plants, fungi, algae, or any combinations thereof. In some embodiments, the non-animal fat or oil is a plant-derived fat or oil. In some embodiments, the non-animal fat or oil comprises palm oil, palm kernel oil, coconut oil, cocoa butter, sunflower oil, safflower oil, fractions of any of the foregoing, or any combinations thereof. For embodiments that comprise a seafood fat or oil, any suitable seafood fat or oil can be used, such as a fat or oil derived from fish or shellfish (such as shrimp or krill). In some embodiments, the seafood fat or oil comprises one or more omega-3 fatty acid esters, such as omega-3 fatty acid glycerides. In some embodiments, the lipid component comprises an algal oil, such as an algal oil comprising one or more omega-3 fatty acid esters, such as omega-3 fatty acid glycerides.

As used herein, a “fraction” of a fat or an oil is a higher-melting portion of the fat or oil that is separated from other components in the fat or oil, for example, by crystallization. Palm stearin is a common example of such a fraction, which is obtained by the slow crystallization of palm oil and the separation of the higher-melting portion that crystallizes when heated palm oil is cooled to a temperature near its melting point. Other examples include shea stearin, rice stearin, and the like. Also, note that the term “oil” is used here with reference to these particular plant-based fats because that is the common term for referring to such fats, even though they are solids at room temperature. In some embodiments, the non-animal fat comprises palm oil or a fraction thereof, such as palm stearin. In some embodiments, the non-animal fat comprises coconut oil. In some embodiments, the non-animal fat comprises palm kernel oil. In some embodiments, the non-animal fat comprises cocoa butter. In some embodiments, the non-animal fat comprises safflower oil. In some embodiments, the non-animal fat comprises sunflower oil. In general, the non-animal fat comprises mostly triglycerides. In some embodiments, some amount of monoglycerides and diglycerides can be present. For example, in some embodiments, the non-animal fat comprises at least 60% by weight, or at least 70% by weight, or at least 80% by weight, or at least 90% by weight, or at least 95% by weight, triglycerides, based on the total weight of glycerides in the ingestible composition.

In some embodiments, the ingestible composition comprises a free fatty acid. In some such embodiments, the free fatty acids are derived from non-animal sources, such as plants, fungi, algae, or any combinations thereof. In some embodiments, the non-animal free fatty acids are derived from plants, such as palm, coconut, or cocoa. Non-limiting examples of free fatty acids suitable for use in the plurality of oleaginous particles include capric acid, lauric acid, myristic acid, palmitic acid, stearic acid, oleic acid, linoleic acid, linolenic acid, eicosapentaenoic acid, docosahexaenoic acid, or any combinations thereof. In some embodiments, the free fatty acid is palmitic acid. In some embodiments, the free fatty acid is stearic acid. In some embodiments, the free fatty acid comprises palmitic acid and stearic acid.

In some embodiments, the ingestible composition comprises one or more hydrocolloids in addition to the gellan gum. Any suitable hydrocolloid can be used. Suitable examples include agar, guar gum, propylene glycol alginate, sodium alginate, acacia fiber, carrageenan, carboxymethylcellulose, methylcellulose, locust bean gum, tara gum, inulin, konjac fiber, pectin, curdlan, and xanthan gum. In some embodiments, one or more of these hydrocolloids may be used in certain amounts to partially offset the quantity of gellan gum.

In some embodiments, the ingestible composition comprises starch. The starch, when present, can be from any suitable source. In some embodiments, the starch is a plant-derived starch. Non-limiting examples of such starches include corn starch, potato starch, cassava starch, wheat starch, rice starch, acorn starch, arrowroot starch, arracacha starch, banana starch, barley starch, breadfruit starch, buckwheat starch, canna starch, Colocasia starch, katakuri starch, kudzu starch, malanga starch, millet starch, oat starch, oca starch, polynesian arrowroot starch, sago starch, sorghum starch, sweet potato starch, rye starch, taro starch, chestnut starch, water chestnut starch, yam starch, almond starch, other nut starches, and various kinds of bean starches, such as fava bean starch, lentil starch, mung bean starch, pea starch, and chickpea starch.

In general, the ingestible composition comprises an aqueous carrier. For example, in some embodiments, water makes up from 50 wt % to 99 wt %, or from 60 wt % to 99 wt %, or from 70 wt % to 99 wt %, or from 50 wt % to 95 wt %, or from 60 wt % to 95 wt %, or from 70 wt % to 95 wt %, water, based on the total weight of the ingestible composition.

The ingestible composition can also include any number of other excipients, such a bulking agent, a desiccant, and the like, as described in further detail below.

The ingestible composition, include, in some embodiments, one or more flavorings, extracts, flavor modifiers, aroma modifiers, or any combination thereof.

In some embodiments, the ingestible compositions disclosed herein comprise a flavoring. In general, the flavoring improves the taste and flavor of the ingestible composition or the resulting flavored product in which the ingestible composition is used. Such improvement includes reducing the bitterness of the ingestible composition or the resulting flavored product, reducing the perception of astringency of the ingestible composition or the resulting flavored product, reducing the perception of green taste notes (such as pea taste) of the ingestible composition or the resulting flavored product, reducing the perception of cereal notes of the ingestible composition or the resulting flavored product, improving the perception of creaminess of the ingestible composition or the resulting flavored product, improving the perception of fattiness of the ingestible composition or the resulting flavored product, improving the perception of sweetness of the ingestible composition or the resulting flavored product, improving the perception of savory taste (umami or kokumi) of the ingestible composition or the resulting flavored product, improving the mouthfeel or mouthcoating of the ingestible composition or the resulting flavored product, improving the perception of juiciness of the ingestible composition or the resulting flavored product, improving the perception of thickness of the ingestible composition or the resulting flavored product.

Any suitable flavoring can be used. In some embodiments, the ingestible composition is used in a seafood analogue product. Thus, in such embodiments, the ingestible composition includes one or more flavorings that impart the taste and/or aroma of fish or shellfish, such as salmon flavoring, shrimp flavoring, squid (calamari) flavoring, and the like.

The gel compositions may be used in other contexts, however. Thus, a wide variety of other flavorings can be included. In some embodiments, the flavoring comprises synthetic flavor oils and flavoring aromatics or oils, oleoresins and extracts derived from plants, leaves, flowers, fruits, and so forth, or combinations thereof. Non-limiting examples of flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Non-limiting examples of other flavors include natural and synthetic fruit flavors such as vanilla, and citrus oils including lemon, orange, lime, grapefruit, yuzu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. In the context of dairy or dairy analog products, the most commonly used flavor agents are agents that impart flavors such as vanilla, French vanilla, chocolate, banana, lemon, hazelnut, coconut, almond, strawberry, mocha, coffee, tea, chai, cinnamon, caramel, cream, brown sugar, toffee, pecan, butter pecan, toffee, Irish crème, white chocolate, raspberry, pumpkin pie spice, peppermint, or any combination thereof.

In some embodiments, the flavoring is a flavoring that provides a savory tonality, including flavorings or tonalities of beef, lamb, bison, smoke, pork, bacon, ham, sausage, chicken, turkey, goose, duck, mushroom, celery, tomato, onion, garlic, carrot, leek, fish, shellfish, soy, miso, and the like. In some further embodiments, the flavoring comprises one or more lactones, which impart a creamy flavor to the ingestible composition.

In some embodiments, the flavoring comprises a yeast extract, such as a yeast lysate. Such extracts can be obtained from any suitable yeast strain, where such extracts are suitable for human consumption. Non-limiting examples of such yeasts include: yeasts of the genus Saccharomyces, such as Saccharomyces cerevisiae or Saccharomyces pastorianus; yeasts of the genus Candida, such as Candida utilis; yeasts of the genus Kluyveromyces, such as Kluyveromyces lactis or Kluyveromyces marxianus; yeasts of the genus Pichia such as Pichia pastoris; yeasts of the genus Debaryomyces such as Debaryomyces hansenii; and yeasts of the genus Zygosaccharomyces such as Zygosaccharomyces mellis. In some embodiments, the yeast is a yeast collected after brewing beer, sake, or the like. In some embodiments, the yeast is a yeast subjected to drying treatment (dried yeast) after collection.

Such extracts can be produced by any suitable means. In general, yeast extracts or lysates are made by extracting the contents of the yeast cells from the cell wall material. In many instances, the digestive enzymes in the cells (or additional enzymes added to the composition) break down the proteins and polynucleotides in the yeast to amino acids, oligopeptides (for example, from 2 to 10 peptides), nucleotides, oligonucleotides (from 2 to nucleotides), and mixtures thereof. A yeast lysate can be prepared by lysing a yeast. For example, in some embodiments, the yeast after culture is crushed or lysed by an enzymatic decomposition method, a self-digestion method, an alkaline extraction method, a hot water extraction method, an acid decomposition method, an ultrasonic crushing method, crushing with a homogenizer, a freezing-thawing method, or the like (two or more thereof may be used in combination), whereby a yeast lysate is obtained. Yeast may be cultured by a conventional method. In some embodiments, the yeast after culture is heat-treated and then treated with a lytic enzyme to obtain an enzyme lysate. The conditions for the heat treatment are, for example, 80° C. to 90° C. for 5 minutes to 30 minutes. As the lytic enzyme used for the enzymatic decomposition method, various enzymes can be used as long as they can lyse the cell wall of yeast. The reaction conditions may be set so as to be optimum or suitable for the lytic enzyme(s) to be used, and specific examples thereof can include a temperature of 50° C. to 60° C., and a pH of 7.0 to 8.0. The reaction time is also not particularly limited, and can be, for example, 3 hours to 5 hours.

Compositions comprising yeast lysate can be obtained from a variety of commercial sources. For example, in some embodiments, the yeast lysate is provides by the flavoring additive sold under the name MODUMAX (DSM Food Specialties BV, Delft, Netherlands).

The flavoring also includes, in certain embodiments, one or more additional flavor-modifying compounds, such as compounds that enhance sweetness (e.g., phloretin, naringenin, glucosylated steviol glycosides, etc.), compounds that block bitterness, compounds that enhance umami, compounds that enhance kokumi, compounds that reduce sourness or licorice taste, compounds that enhance saltiness, compounds that enhance a cooling effect, compounds that enhance mouthfeel, or any combinations of the foregoing.

In some embodiments, the ingestible composition comprises a sweetener. The sweetener can be present in any suitable concentration, depending on factors such as the sweetener's potency as a sweetener, its solubility, and the like.

In general, the ingestible compositions disclosed herein can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arabinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phloridzin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, super aspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

In some embodiments, the flavoring comprises one or more sweetness enhancing compounds. Such sweetness enhancing compounds include, but are not limited to, naturally derived compounds, such as hesperitin dihydrochalcone, hesperitin dihydrochalcone-4′-O′glucoside, neohesperidin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, eriodictyol, homoeriodictyol, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide or N-(1-((4-amino-2,2-dioxo-1H-benzo[c][1,2,6]thiadiazin-5-yl)oxy)-2-methyl-propan-2-yl)-isonicotinamide.

In some further embodiments, the flavoring comprises one or more umami enhancing compounds. Such umami enhancing compounds include, but are not limited to, naturally derived compounds, or synthetic compounds, such as any compounds set forth in U.S. Pat. Nos. 8,735,081; 8,124,121; and 8,968,708. In some embodiments, the umami-enhancing compound is (2R,4R)-1,2,4-trihydroxy-heptadec-16-ene, (2R,4R)-1,2,4-trihydroxyheptadec-16-yne, or a mixture thereof. In some embodiments, the umami-enhancing compound is (3R,5S)-1-(4-hydroxy-3-methoxyphenyl) decane-3,5-diol diacetate. In some embodiments, the umami-enhancing compound is N-(heptan-4-yl)benzo[d][1,3]dioxole-5-carboxamide.

In some embodiments, the ingestible composition comprises one or more compounds commonly used in savory products. Such flavorings include glutamates (such as MSG), arginates, avocadene, avocadyne, a purine ribonucleitide (such as inosine monophosphate (IMP), guanosine monophosphate (GMP), hypoxanthine, inosine), a yeast extract (as noted above), a fermented food product, cheese, garlic or extracts thereof, a gamma-glutamyl-containing polypeptide, a gamma-glutamyl-containing oligopeptide (such as gamma-glutamyl-containing tripeptides); an flavor-modifying composition (such as a cinnamic acid amide or a derivative thereof), a nucleotide, an oligonucleotide, a plant extract, a food extract, or any combinations thereof.

In some further embodiments, the flavoring comprises one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, the flavoring comprises one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759, or in PCT Publication No. WO 2020/033669. In some embodiments, the bitterness blocking compound is 3-(1-((3,5-dimethylisoxazol-4-yl)-methyl)-1H-pyrazol-4-yl)-1-(3-hydroxybenzyl)-imidazolidine-2,4-dione.

In some further embodiments, the flavoring comprises one or more sour taste modulating compounds.

In some further embodiments, the flavoring comprises one or more mouthfeel modifying or mouthfeel enhancing compounds. Such mouthfeel modifying compounds include, but are not limited to, polymethoxylated flavones, tannins, cellulosic materials, bamboo powder, and the like.

In some further embodiments, the flavoring comprises one or more flavor masking compounds. Such flavor masking compounds include, but are not limited to, cellulosic materials, materials extracted from fungus, materials extracted from plants, citric acid, carbonic acid (or carbonates), and the like.

In some embodiments, the flavor-modifying compounds described above are included to improve other tastants that may be present in the comestible composition itself, or that may be included within the flavored products that employ such compositions. Such tastants include sweeteners, umami tastants, kokumi tastants, bitter tastants, sour tastants, and the like.

In some embodiments, the ingestible comprises one or more metal salts or metal complexes, such as iron salts or iron complexes. Such compounds can include any comestible metal salt or complex, such as salts or complexes of calcium, magnesium, sodium, potassium, iron, cobalt, copper, zinc, manganese, molybdenum, and selenium. In some embodiments, the iron compound is an iron salt or an iron complex. In some particular embodiments, the metal compound is a ferrous (Fe²⁺) salt or a ferrous (Fe²⁺) complex. In some embodiments, the metal compound is a ferrous (Fe²⁺) salt, such as ferrous sulfate, ferrous lactate, ferrous fumarate, ferrous gluconate, ferrous succinate, ferrous chloride, ferrous oxalate, ferrous nitrate, ferrous citrate, ferrous ascorbate, ferric citrate, ferric phosphate, or any combination thereof. In some other embodiments, the metal compound is a ferric (Fe³⁺) salt or a ferric (Fe³⁺) complex, such as ferric pyrophosphate. In some embodiments, the iron compound is ferrous lactate, ferrous sulfate, or any combination thereof.

In some embodiments, the iron compound is a heme-containing protein. As used herein, the term “heme containing protein” includes any polypeptide covalently or noncovalently bound to a heme moiety. In some embodiments, the heme-containing polypeptide is a globin and can include a globin fold, which comprises a series of seven to nine alpha helices. Globin type proteins can be of any class (for example, class I, class II, or class III), and in some embodiments, can transport or store oxygen. For example, a heme-containing protein can be a non-symbiotic type of hemoglobin or a leghemoglobin. A heme-containing polypeptide can be a monomer, such as a single polypeptide chain, or can be a dimer, a trimer, tetramer, and/or higher order oligomer. The lifetime of the oxygenated Fe²⁺ state of a heme-containing protein can be similar to that of myoglobin or can exceed it by 10%, or 20%, or 30%>, or 40%, or 50%, or even 100%, or more under conditions in which the heme-protein-containing consumable is manufactured, stored, handled or prepared for consumption.

Non-limiting examples of heme-containing proteins include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the comestible compositions described herein and can be from mammals (for example, farm animals such as cows, goats, sheep, pigs, ox, or rabbits), birds, plants, algae, fungi (for example, yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola), Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. Heme-containing proteins can be isolated from bacteria such as Escherichia coli, Bacillus subtilis, Bacillus licheniformis, Bacillus megaterium, Synechocistis sp., Aquifex aeolicus, Methylacidiphilum infernorum, or thermophilic bacteria such as Thermophilus spp. The sequences and structure of numerous heme-containing proteins are known. See, for example, Reedy, et al, Nucleic Acids Research, 2008, Vol. 36, Database issue D307-D313 and the Heme Protein Database available on the world wide web at http://hemeprotein.info/heme.php.

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice.

In some embodiments, the heme-containing protein is a leghemoglobin, such as a soy, pea, or cowpea leghemoglobin.

Heme-containing or other proteins also can be recombinantly produced using polypeptide expression techniques (e.g., heterologous expression techniques using bacterial cells, insect cells, fungal cells such as yeast, plant cells such as tobacco, soybean, or Arabidopsis, or mammalian cells). For example, leghemoglobin can be recombinantly produced in E. coli or Pichia pastoris. In some cases, standard polypeptide synthesis techniques (such as liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

The heme-containing proteins or iron salts can be used at any suitable concentration. Examples are set forth in PCT Publication No. WO 2015/153666, which is incorporated herein by reference.

The iron compound can make up any suitable weight of the ingestible particle. In some embodiments, the iron compound makes up from 0.1 percent by weight to 10 percent by weight, or from 0.2 percent by weight to 5 percent by weight, or from 0.5 percent by weight to 3 percent by weight, of the ingestible composition, based on the total dry weight of the ingestible composition.

Various other additives can be included in the ingestible composition or can be introduced to the ingestible composition.

For example, in some embodiments, the ingestible composition comprises an emulsifier. Any suitable emulsifier can be used. For example, in some non-limiting embodiments, the emulsifier comprises lecithin, monoglycerides, diglycerides, polysorbates, vegetable oils, and the like. In some embodiments, the emulsifier comprises lecithin. Other examples of emulsifiers can be found in McCutcheon's Emulsifiers & Detergents or the Industrial Surfactants Handbook. The emulsifier can be present in any suitable concentration, which can be adjusted so as to form a stable emulsion of the other components in the comestible composition, for example, when incorporated into a flavored product.

In some instances, it may be desirable to include additives that assist in adjusting the viscosity of the ingestible composition (for example, when the ingestible composition is introduced into water or includes water). Various salts and acids can be used to carry out such adjustments. In some embodiments, the comestible composition or the resulting flavored product comprises one or more salts. Non-limiting examples of suitable salts include magnesium sulfate, sodium chloride, sodium sulfate, calcium chloride, calcium sulfate, potassium sulfate, potassium chloride, potassium sorbate, potassium phosphate, potassium monophosphate, zinc chloride, zinc sulfate, or any mixtures thereof. In some embodiments, the comestible composition or the resulting flavored product also comprises one or more acids, which may be used alone or in combination with the aforementioned salts. Non-limiting examples of suitable acids include citric acid, lactic acid, acetic acid, tartaric acid, succinic acid, ascorbic acid, maleic acid, phosphoric acid, monopotassium phosphate, gluconic acid, glucono-lactone, glucoronic acid, glycyrrhetic acid, folic acid, pantothenic acid or mixtures thereof.

The ingestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins, minerals, or other functional ingredients including, for example resveratrol, Co-Q10, omega 3 fatty acids, theanine, choline chloride (citicoline), fibersol, inulin (chicory root), taurine, panax ginseng extract, guanana extract, ginger extract, L-phenylalanine, L-carnitine, L-tartrate, D-glucuronolactone, inositol, bioflavonoids, Echinacea, Ginko biloba, yerba mate, flax seed oil, garcinia cambogia rind extract, white tea extract, ribose, milk thistle extract, grape seed extract, pyroxidine HCl (vitamin B6), cyanocobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, iodine, riboflavin, sodium sulfate, sodium gluconate, sodium polyphosphate, sodium bicarbonate, thiamine mononitrate, vitamin D3, vitamin A palmitate, zinc gluconate, zinc lactate, zinc sulphate, or selenium;
clouding agents, including, for example ester gun, brominated vegetable oil (BVO), or sucrose acetate isobutyrate (SAIB);
buffers, including, for example sodium citrate, potassium citrate, or salt;
propylene glycol, ethyl alcohol, glycerine, gum Arabic (gum acacia), modified corn starch, silicon dioxide, magnesium carbonate, or tricalcium phosphate; or starches and stabilizers, including, for example, polysorbate 60, polysorbate 80, medium chain triglycerides, and the like.

In some embodiments, component (a) can further comprise galact-oligosaccharides, fructo-oligosaccharides, acacia fiber, soluble pea fiber, soluble wheat fiber, arabinoxylan, isomalto-oligosaccharides, xylo-oligosaccharides, and the like.

The comestible composition can contain any of a number of ingredients, such as ingredients typically included in meat analogue products.

For example, in some embodiments, the comestible composition comprises a flavored water-in-oil emulsion according to any of the embodiments set forth in PCT Publication No. WO 2020/260628, which is hereby incorporated by reference.

In some embodiments, the comestible composition comprises encapsulated flavor compositions according to any of the embodiments set forth in PCT Publication No. WO 2021/104846, which is hereby incorporated by reference.

In some embodiments, the ingestible composition further comprises a carrier and, optionally, at least one adjuvant. The term “carrier” denotes a usually inactive accessory substance, such as solvents, binders, bulking agents, or other inert medium, which is used in combination with the present compound and one or more optional adjuvants to form the formulation. For example, water or starch can be a carrier for a flavored product. In some embodiments, the carrier is the same as the diluting medium for reconstituting the flavored product; and in other embodiments, the carrier is different from the diluting medium. The term “carrier” as used herein includes, but is not limited to, comestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

The ingestible composition may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavored product. The examples of the freezing point depressant include, but are not limited to, carbohydrates, oils, ethyl alcohol, polyol, e.g., glycerol, and combinations thereof. The nucleating agent denotes an ingestibly acceptable compound or agent that facilitates nucleation. The presence of nucleating agent in the flavored product can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

### Methods of Preparation

The ingestible compositions disclosed herein can be made by any suitable means, as typically employed in the manufacturing of products containing such blends. Such methods include dry mixing, wet mixing, granulating, encapsulating, spray drying, and the like. In some embodiments, the ingestible compositions are prepared by spray drying, where the protein compositions are mixed with a liquid medium that is removed by drying during a spraying process. Spray drying processes are well known in the art of preparing comestible products. Any suitable spray-drying process can be used and optimized for the components used in the ingestible compositions. In some embodiments, the ingestible compositions are prepared by extrusion, where the protein compositions are mixed with other materials and is formed into an shaped article by extrusion. Extrusion processes are well known in the art of preparing comestible products. Any suitable extrusion process or apparatus can be used and optimized for the components used in the ingestible compositions.

### Flavored Products

In certain aspects, the disclosure provides a flavored product, which comprises the ingestible composition according to any of the embodiments set forth above. The ingestible composition can be present in the flavored product in any suitable amount. In some embodiments, for example, the ingestible composition makes up from 10 wt % to 99 wt %, or from 20 wt % to 99 wt %, or from 30 wt % to 99 wt %, or from 40 wt % to 99 wt %, or from 50 wt % to 99 wt %, of the flavored product, based on the total weight of the flavored product.

In some embodiments, the flavored product is a food product, such as a seafood analogue product. Certain non-limiting examples of such seafood analogue products include a salmon analogue product, a squid (calamari) analogue product, a shrimp analogue product, a crabmeat analogue product, and the like. In some embodiments, the flavored product is a meat analogue product, such as a poultry analogue product, a pork analogue product, and the like. In some embodiments, the flavored products contain no animal-derived products.

In some embodiments, the flavored product further comprises one or more seafood-derived components, such as juice or extract of seafood, meat of seafood, eggs of seafood, and the like. Such seafood-derived products can come from any suitable seafood source, including, but not limited to, fish (such as pollock, cod, tilapia, salmon, halibut, swordfish, tuna, herring, mackerel, perch, sardines, anchovies, tilefish, trout, mahi-mahi, bass, char, branzino, hake, sea bream, brill, yellowtail, snapper, haddock, turbot, basa, red mullet, walleye, catfish, amberjack, sole, flounder, and the like), crab, clams, mussels, oysters, squid, octopus, cuttlefish, winkles, scallops, sea urchin, sea pineapple, shrimp, crayfish, and lobster. Such seafood-derived products can be present in the flavored product in any suitable amount. In some embodiments, for example, such seafood-derived products make up from 1 wt % to 50 wt %, or from 1 wt % to 40 wt %, or from 1 wt % to 30 wt %, or from 1 wt % to 20 wt %, or from 1 wt % to 10 wt %, of the flavored product, based on the total weight of the flavored product.

In some other embodiments, the flavored product is a meat-replacement product (or meat analogue), such as a product designed to mimic products traditionally made from red meat. For example, the flavored product can be a meat analogue dough, such as those described in PCT Publication No. WO 2015/153666. Such flavored products can be designed to simulate beef products, such as ground beef (for making burgers) or cuts of beef for inclusion in soups, prepared meals, and the like. The flavored products can also be designed to simulate cuts or ground forms of other meat, such as chicken, turkey, pork, goat, lamb, venison, and bison, or seafood, such as fish or shellfish (crab, scallop, shrimp, squid, and the like).

Such seafood or meat analogue products can be made by any suitable means. For seafood analogue products, the resulting product would ordinarily have a particular shape and color indicative of the shape and color of the seafood product they are designed to replicate. For example, a calamari analogue product may be formed in the shape of a ring, which is indicative of sliced rings of squid meat. Or a shrimp analogue product may be formed in the shape of a peeled piece of shrimp and may have orange color added to simulate the appearance of cooked shrimp. Or a fish analogue product, such as a salmon analogue, may be formed in the shape of a fillet or steak and may have orange and pink color added to simulate the appearance of an actual salmon fillet or steak.

Such shaping can be carried out by any suitable means. In some embodiments, such seafood analogue products are formed by a molding process, where the ingredients are placed into a mold and the seafood analogue product gels within the mold to form a molded product. In some other embodiments, the seafood analogue products can be formed by an extrusion process, such as a dynamic extrusion process.

In some embodiments, the gel composition or the seafood analogue product comprises a colorant, such as a natural colorant. In some embodiments, the colorant is a beta-carotene.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described and claimed herein.

### Example 1—Vegan Calamari Analogue

Table 1 below sets forth the list of ingredients and their relative proportion for making a vegan calamari analogue.

TABLE 1

| Ingredient | Amount (wt %) |
|---|---|
| Gellan Gum - High Acyl | 0.99 |
| Gellan Gum - Low Acyl | 0.50 |
| Sodium Citrate | 0.06 |
| Calcium Sulfate | 2.13 |
| Sodium Chloride | 0.25 |
| Bamboo Fiber | 1.49 |
| Soy Protein Isolate | 11.11 |
| Sunflower Oil | 2.48 |
| Corn Fiber | 1.98 |
| Bitter Masking Agent | 0.18 |
| Seafood Flavoring | 1.18 |
| Water | balance |

All of the dry components were blended together, and then dispersed in water using a Thermomix mixer. After the dry ingredients were homogeneously dispersed in the water, the resulting composition was heated to 90-95° C. using indirect steam injection. The temperature was maintained at about 90° C. for a period of time and was transferred to a mold having the desired calamari shape. The mold was then transferred to a refrigerator for cooling. The material was cooled for about one day.

### Example 2—Vegan Salmon Analogue

Table 2 below sets forth the list of ingredients and their relative proportion for making a vegan salmon analogue.

TABLE 2

| Ingredient | Amount (wt %) |
|---|---|
| Gellan Gum - High Acyl | 0.79 |
| Gellan Gum - Low Acyl | 0.40 |
| Sodium Citrate | 0.06 |
| Calcium Sulfate | 0.99 |
| Sodium Chloride | 0.60 |
| Bamboo Fiber | 1.50 |
| Pea Protein Isolate | 12.51 |
| Sunflower Oil | 2.48 |
| Corn Fiber | 1.99 |
| Salmon/Seafood Flavoring | 0.93 |
| Beta-Carotene (Coloring) | 0.03 |
| Water | balance |

All of the dry components were blended together, and then dispersed in water using a Thermomix mixer. After the dry ingredients were homogeneously dispersed in the water, the resulting composition was heated to 90-95° C. using indirect steam injection. The temperature was maintained at about 90° C. for a period of time and was transferred to a mold having the desired salmon fillet shape. The mold was then transferred to a refrigerator for cooling. The material was cooled for about one day.

### Example 3—Vegan Shrimp Analogue

Table 3 below sets forth the list of ingredients and their relative proportion for making a vegan shrimp analogue.

TABLE 3

| Ingredient | Amount (wt %) |
|---|---|
| Gellan Gum - High/Low Acyl Blend | 1.70 |
| Sodium Citrate | 0.10 |
| Calcium Sulfate | 1.40 |
| Sodium Chloride | 0.25 |
| Bamboo Fiber | 0.90 |
| Potato Starch | 0.90 |
| Soy Protein Isolate | 3.00 |
| Soy Protein Concentrate | 2.04 |
| Bitterness Masking Agent | 0.18 |
| Shrimp Flavoring | 0.14 |
| Water | balance |

All of the dry components were blended together, and then dispersed in water using a Thermomix mixer. After the dry ingredients were homogeneously dispersed in the water, the resulting composition was heated to 90-95° C. using indirect steam injection. The temperature was maintained at about 90° C. for a period of time and was transferred to a mold having the desired shrimp shape. The mold was then transferred to a refrigerator for cooling. The material was cooled for about one day.

1. An ingestible composition for making a seafood analogue product or a meat analogue product, the composition comprising a gellan gum and a non-animal protein;
wherein the non-animal protein makes up from 20 wt % to 80 wt % of the ingestible composition, based on the total dry weight of the ingestible composition;
wherein the gellan gum comprises a blend of a high-acyl gellan gum and a low-acyl gellan gum, and makes up from 1 wt % to 25 wt % of the ingestible composition, based on the total dry weight of the ingestible composition.

2-3. (canceled)

4. The ingestible composition of claim 1, wherein the non-animal protein is a plant protein.

5. The ingestible composition of claim 4, wherein the plant protein is soy protein, pea protein, or a combination thereof.

6. The ingestible composition of claim 1, further comprising a plant fiber.

7. The ingestible composition of claim 1, further comprising a lipid component.

8. The ingestible composition of claim 7, wherein the lipid component is a plant-based oil, a plant-based fat, or a combination thereof.

9. The ingestible composition of claim 1, further comprising an alkali metal salt, an alkali earth metal salt, or a combination thereof.

10. The ingestible composition of claim 1, further comprising a flavoring, such as a seafood flavoring.

11. The ingestible composition of claim 1, wherein the ingestible composition is in the form of a gel.

12. A seafood analogue product, which comprises an ingestible composition of claim 1.

13. The seafood analogue product of claim 12, wherein the seafood analogue product is a fish analogue product or a shellfish analogue product.

14. A meat analogue product, which comprises an ingestible composition of claim 1.

15. The meat analogue product of claim 14, wherein the meat analogue product is a poultry analogue product.
